(19) United States
(12) Patent Application Publication
(10) Pub. No.: US 2003/0225831 A1
(43) Pub. Date: Dec. 4, 2003

(54) Center server and computer apparatus

(76) Inventor: Arito Asai, Asaka-shi (JP)

Correspondence Address: BIRCH STEWART KOLASCH & BIRCH, PO BOX 747, FALLS CHURCH, VA, 22040-0747, US

(21) Appl. No.: 10/448,193

(22) Filed: May 30, 2003

(30) Foreign Application Priority Data
May 31, 2002 (JP) 2002-158456

(51) Int. Cl. G06F 15/16; G09G 5/00

(52) U.S. Cl. 709/203; 709/219; 345/748

(57) ABSTRACT

When a specific group of computers is created on a network, a first computer applies a group creation command to a center server. The latter generates an identification code corresponding to a new group and transmits the code to the first computer as a file. The first computer transmits the identification code file as by E-mail to other computers (second computers) that create a specific group. Any of these second computers that has received the identification code file is registered with the center server. A computer having a specific identification code becomes a member of the specific group. A computer issues a request for images to computers within the specific group. A computer that has received the request for images transmits the image files to the computer that issued the request. This makes it possible to share content such as imaged within the specific group.

### BACKGROUND OF THE INVENTION

1. Field of the Invention

This invention relates to a center server and to a computer apparatus.

2. Description of the Related Art

Content can be shared by a number of computers constructing a peer-to-peer system. If content has not been stored in one computer but has been stored in another computer, then the content that has been stored in this other computer can be acquired by the first-mentioned computer.

In a system in which content is capable of being shared, often the sharing of content within a specific group is not taken into consideration.

### SUMMARY OF THE INVENTION

Accordingly, an object of the present invention is to share content within a specific group.

According to a first aspect of the present invention, the foregoing object is attained by providing a center server capable of communicating with one computer apparatus and another computer apparatus. The center server comprises an identification code generating device for receiving a sharing-group creation command and data, which represents the address of the one computer apparatus, transmitted from the one computer apparatus, and generating a unique identification address in accordance with the received sharing-group creation command; an identification code transmitting device for transmitting the identification code, which has been generated by the identification code generating device, to the one computer apparatus; a list generating device for generating an address/identification code list in which the identification code generated by the identification code generating device and the address of the one computer apparatus are made to correspond to each other; and a storage control device for storing the identification code and the address of the other computer apparatus, which have been transmitted from the other computer apparatus, in the address/identification code list.

Further, a control method suited to the center server according to the first aspect of the present invention is also provided. Specifically, according to the first aspect of the present invention, there is provided a method of controlling a center server capable of communicating with one computer apparatus and another computer apparatus, the method comprising the steps of: receiving a sharing-group creation command and data, which represents the address of the one computer apparatus, transmitted from the one computer apparatus; generating a unique identification address in accordance with the received sharing-group creation command; transmitting the generated identification code to the one computer apparatus; generating an address/identification code list in which the generated identification code and the address of the one computer apparatus are made to correspond to each other; and storing the identification code and the address of the other computer apparatus, which have been transmitted from the other computer apparatus, in the address/identification code list.

In accordance with the present invention, one computer transmits its address and a sharing-group creation command to a center server.

Upon receiving the sharing-group creation command and the address of the one computer that have been transmitted from this computer, the center server generates a unique identification code. When the identification code is generated, the center server generates an address/identification code list in which the generated identification code and the address of the one computer are made to correspond to each other. Further, the center server transmits the generated identification code to the one computer that issued the sharing-group creation command.

Since the identification code generated at the center server is transmitted to the one computer that transmitted the sharing-group creation command to the center server, the user of this computer is capable of ascertaining the unique identification code that was generated in response to transmission of the sharing-group creation command to the center server.

The user of another computer who desires to participate in the sharing group has the user of the one computer inform him, as by E-mail, of the identification code that was generated at the center server. The user of the other computer which has thus been informed of the identification code then transmits this identification code as well as its address to the center server.

The center server receives the identification code and the address of the other computer that have been transmitted from this computer, whereupon the received identification code and the address of the other computer are stored in the address/identification code list. Computers whose addresses among those stored in the address/identification code list have common identification codes form a sharing group. Thus, a sharing group comprising specific computers can be formed.

In a second aspect of the present invention, the address of a sharing group thus formed is allowed to be acquired by a computer apparatus.

According to the second aspect of the present invention, there is provided a center server comprising a memory for storing an address/identification code list in which unique identification codes generated in the center server and addresses of computer apparatus correspond to each other; a retrieval device for retrieving an address, which corresponds to an identification code transmitted from a computer apparatus, from the address/identification code list; and an address data transmitting device for transmitting data, which represents the address retrieved by the retrieval device, to the computer apparatus that transmitted the identification code.

Further, a control method suited to the center server according to the second aspect of the present invention is also provided. Specifically, according to the second aspect of the present invention, there is provided a method of controlling a center server comprising the steps of: storing an address/identification code list in which unique identification codes generated in the center server and addresses of computer apparatus correspond to each other; retrieving an address, which corresponds to an identification code transmitted from a computer apparatus, from the address/identification code list; and transmitting data, which represents the address retrieved, to the computer apparatus that transmitted the identification code.

In accordance with the second aspect of the present invention, the address/identification code list generated in the manner described above is stored in the memory of the center server.

The user of a computer (one computer) that has issued a sharing-group creation command is informed of an identification code by a computer that acquires the address of the sharing group. The identification code that has been reported is transmitted to the center server from a computer (which may be the other computer or the one computer).

Upon receiving an identification code transmitted from a computer, the center server retrieves the address corresponding to the received identification code from the address/identification code list. The data representing the retrieved address is transmitted from the center server to the computer.

The computer apparatus receives address data (a computer list) from the center server. The address represented by the received address data is the address of the computer that constitutes a sharing group. This makes it possible to request content from the computer constituting the sharing group.

In a third aspect of the present invention, a computer apparatus constituting a sharing group is requested for content.

According to the third aspect of the present invention, there is provided a computer apparatus comprising a first transmitting device for transmitting an identification code to a center server storing an address/identification code list in which identification codes and addresses of computer apparatus correspond to each other; a receiving device for receiving address data transmitted from the center server in response to transmission of the identification code from the first transmitting device to the center server; and a second transmitting device for transmitting a retrieval request for content, which corresponds to the identification code transmitted to the center server, to a computer apparatus having the address represented by the address data received by the receiving device.

Further, a control method suited to the computer apparatus according to the third aspect of the present invention is also provided. Specifically, according to the third aspect of the present invention, there is provided a method of controlling a computer apparatus comprising the steps of: transmitting an identification code to a center server storing an address/identification code list in which unique identification codes and addresses of computer apparatus correspond to each other; receiving address data transmitted from the center server in response to transmission of the identification code to the center server; and transmitting a retrieval request for content, which corresponds to the identification code transmitted to the center server, to a computer apparatus having the address represented by the address data received.

In accordance with the third aspect of the present invention, a computer transmits an identification code to a center server where an address/identification code list has been stored. Upon receiving the identification code, the center server retrieves an address corresponding to the received code from the address/identification code list. Data representing the retrieved address is transmitted from the center server to the computer. Thus, the user of this computer ascertains the address of a computer that constitutes a sharing group. A computer apparatus constituting a sharing group can be requested to retrieve content. The search is conducted by the computer apparatus that received the retrieval request. Content that has been found by retrieval is transmitted to the computer apparatus that issued the request.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a diagram illustrating the configuration of a content sharing system;

FIG. 2 is a block diagram illustrating the electrical structure of a center server;

FIG. 3 is a flowchart illustrating processing for creating a sharing group;

FIG. 4 is a diagram illustrating an example of a window displayed on a computer monitor;

FIG. 5A illustrates a pull-down menu of a “FILE” menu and FIG. 5B a pull-down menu of a “GROUP” menu;

FIG. 6 is a diagram illustrating an example of a dialog box for entering a group name;

FIG. 7 is a diagram illustrating an example of a sharing-group name/identification code list;

FIG. 8 is a diagram illustrating an example of a dialog box for setting an identification-code storage destination;

FIG. 9 is a flowchart illustrating processing for installing an identification code;

FIG. 10 is a diagram illustrating an example of a dialog box for setting an identification code;

FIG. 11 illustrates an example of a folder icon;

FIG. 12 is a flowchart illustrating processing for acquiring a computer list;

FIG. 13 is a diagram illustrating an example of an IP address/identification code list;

FIG. 14 is a diagram illustrating an example of a computer list;

FIG. 15 is a flowchart illustrating processing for requesting an image or the like; and

FIG. 16 is a diagram illustrating an example of a window displayed on a display screen.

### DESCRIPTION OF THE PREFERRED EMBODIMENT

A preferred embodiment of the present invention will now be described in detail with reference to the accompanying drawings.

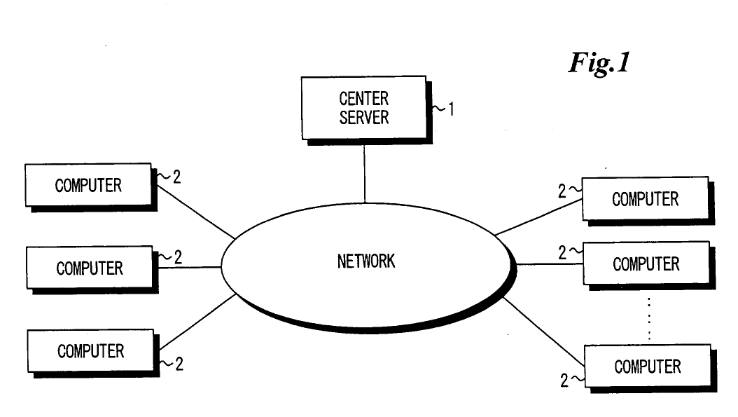

FIG. 1 illustrates the configuration of a content sharing system according to a preferred embodiment of the invention.

The content sharing system comprises a center server 1 and a number of computers 2 capable of communicating with one another via network such as the Internet. The content sharing system is a peer-to-peer system. A number of the computers 2 are client computers that transmit a request command for content (images, sounds, programs, files, folders, etc) to other computers 2, and server computers that transmit content in response to a content request command.

The content sharing system according to this embodiment creates a specific group among the number of computers 2. Only the computers within this specific group can share content. The details of this system will become apparent from the description that follows.

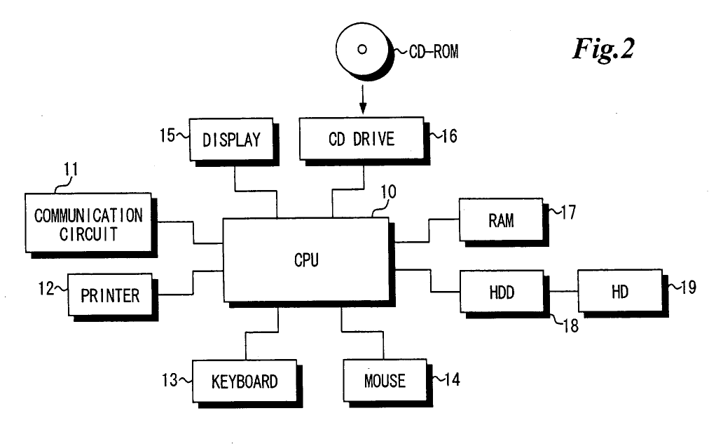

FIG. 2 is a block diagram illustrating the electrical structure of the center server 1.

The operation of the center server 1 is controlled by a CPU 10.

A CD (Compact Disk) drive 16 is connected to the center server 1. A CD-ROM (Compact Disk-Read-Only Memory) on which a program has been stored is loaded in the CD drive 16 and the program is read from the CD-ROM, whereby the program (described later) is installed in the center server 1. Programs are installed similarly in the computers 2.

The center server 1 includes a keyboard 13 and mouse 14. Output signals from the keyboard 13 and mouse 14 are input to the CPU 10.

Connected to the CPU 10 are a display unit 15 for displaying an image represented by an image file or the like, a communication circuit 11 for communicating with the computers 2, and a printer 12 for printing images, etc.

Further connected to the CPU 10 of the center server 1 are a RAM 17 for storing data temporarily, and a hard-disk drive 18 for writing data to and reading data from a hard disk 19.

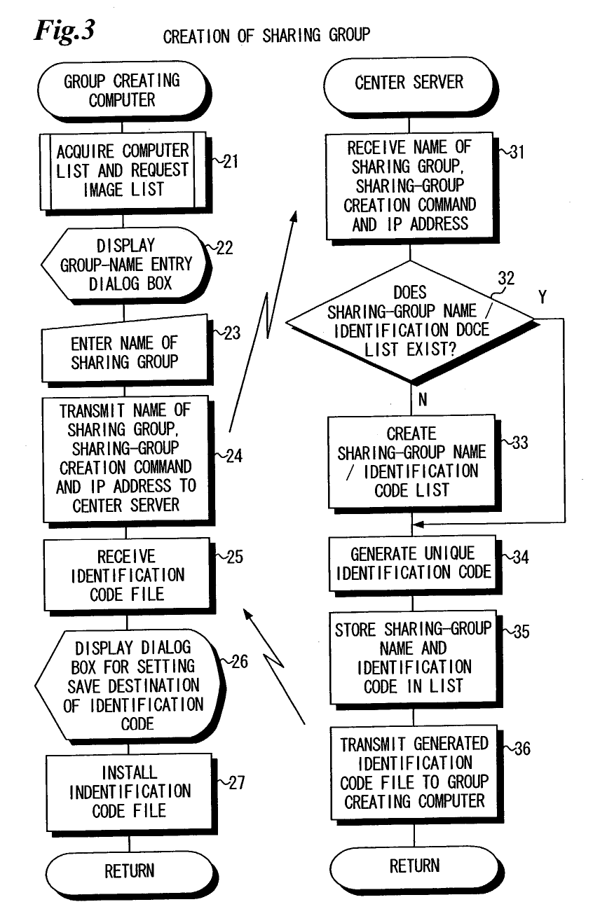

FIG. 3 is a flowchart illustrating processing for creating a sharing group.

Creation of a sharing group is performed between the computers 2 and the center server 1. (A computer used to create a sharing group shall be referred to as a “group creating computer”. Group creating computers may be any computers among the number of computers 2, as shown in FIG. 1.)

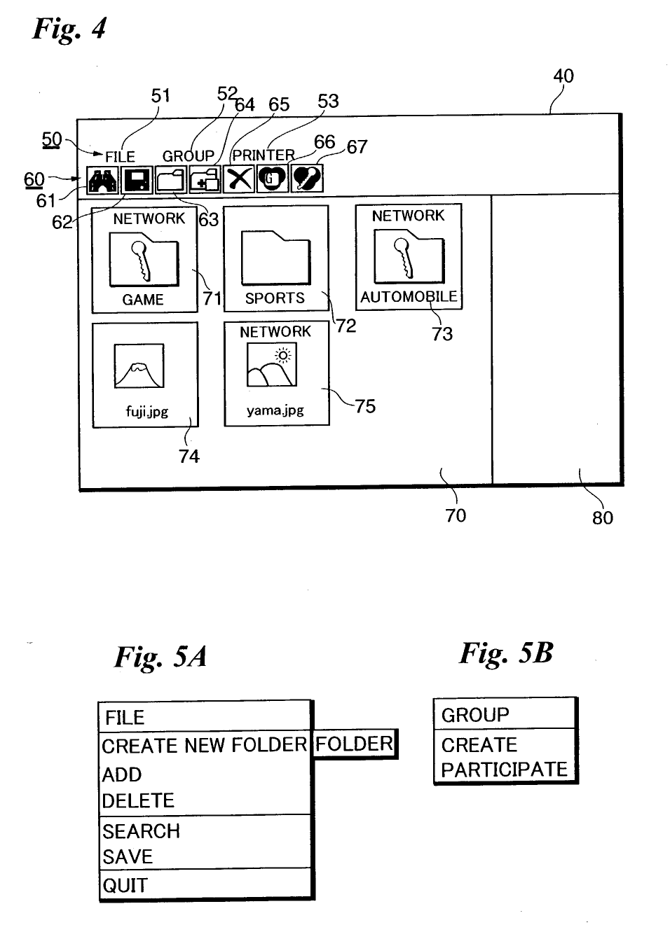

A content sharing program is launched in the group creating computer. When this occurs, the group creating computer accesses the center server 1 and sends the center server 1 an identification code that has been stored in an identification code file installed in the group creating computer. Processing for acquiring a computer list and processing for requesting an image list is executed (step 21). This processing will be described later in detail. A file sharing window 40 illustrated in FIG. 4 is displayed on the display screen of a display unit of the group creating computer.

The file sharing window 40 includes the following areas:

Menu Bar Area 50:

This area includes a “FILE” menu 51, a “GROUP” menu 52 and a “PRINTER” menu 53. By clicking on each menu, a corresponding pull-down menu is displayed. A pull-down menu that displays characters indicating items for creation of a new folder, addition, deletion, search, save and quit appears, as shown in FIG. 5A, in response to clicking of the “FILE” menu 51. A pull-down menu that displays characters indicating items for creation and participation appears, as shown in FIG. 5B, in response to clicking of the “GROUP” menu 52. By clicking on an item being displayed in this pull-down menu, a command corresponding to the item is applied to the group creating computer (computer 2).

Tool Button Area 60:

This is an area for applying a command, which is identical to a command applied to a computer 2 in response to pulling down each menu of the menu bar area 50 and clicking on each item in this menu, to the group creating computer in response to clicking of each button. The following icons are displayed in the tool button area 60: a search icon 61 (this icon is clicked when an image that has been disclosed on the network is searched using a key word); a save icon 62 (this icon is clicked when an image that has been disclosed on the network is saved); a folder creation icon 63 (this icon is clicked when a folder for disclosure is created); addition icon 64 (this icon is clicked when an image is added on); a deletion icon 65 (this icon is clicked when an image is deleted); a group creation icon 66 (this icon is clicked when a specific sharing group is created); and a group participation icon 67 (this icon is clicked when a specific sharing group is to be participated in).

Network Display Area 70:

This is an area for displaying images that have been stored in the computers 2 (both the group creating computer and other computers 2) and folder icons indicative of various groups. A folder icon having a key symbol is displayed in a section 71. Characters indicative of a network are displayed on this folder icon, and characters reading “GAME”, which is the group name specified by this folder icon, are displayed below this folder icon. The key symbols appearing on folder icons indicate that content is being shared only by computers 2 in a specific group among the number of computers 2 connected by the network. A folder icon devoid of a key symbol is displayed in a section 72. A group name “SPORTS” specified by this folder icon is displayed below the folder icon. Characters reading “NETWORK” do not appear on this folder icon in section 72. Thus, the fact that a folder has been stored on the hard disk of the group creating computer is indicated. In a manner similar to that of section 71, section 73 indicates that “AUTOMOBILE” images are being shared by the computers belonging to the specific group. An image (file name: fuji.jpg) that has been stored in the group creating computer is being displayed in a section 74. A section 75 includes characters indicative of the network. This section also indicates that an image (file name: yama.jpg) that has been disclosed on the network is being displayed.

Printer Display Area 80:

This area is for displaying images of printers that can be shared on the network.

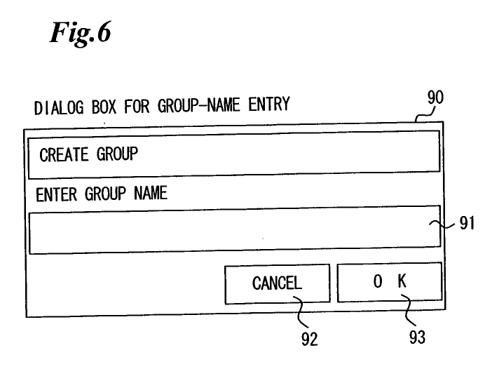

In a case where a sharing group is to be created, either the “GROUP” menu 52 is pulled down and “CREATE” is selected or the group creation icon 66 is clicked. When this is done, a group-name entry dialog box 90 shown in FIG. 6 is displayed on the monitor of the group creating computer (step 22).

The group-name entry dialog box 90 includes a group-name display area 91, a cancel area 92 and an OK area 93. If a group name is entered by the user of the group creating computer 2 (step 23), the entered group name is displayed in the group-name display area 91. If the cancel area 92 is clicked, the entered group name is cancelled. If the OK area 93 is clicked, the entered group name is transmitted to the center server 1 along with a sharing-group creation command and the IP (Internet Protocol) address of the group creating computer (step 24).

When the center server 1 receives data representing the group name, the sharing-group creation command and the IP address of the group creating computer transmitted from the group creating computer 2 (step 31), the center server 1 checks to see whether a sharing-group name/identification code list has already been generated (step 32).

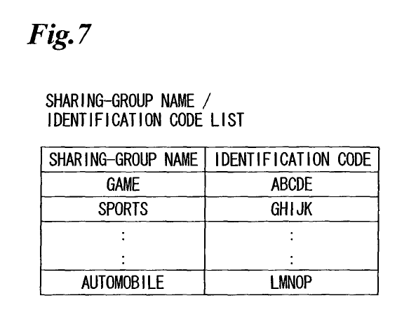

FIG. 7 illustrates an example of the sharing-group name/identification code list.

The sharing-group name/identification code list is used to generate unique identification codes. Generated identification codes are stored in the sharing-group name/identification code list in correspondence with sharing-group names that have been entered at the group creating computer.

If a sharing-group name/identification code list has not been created (“NO” at step 32), then the center server 1 creates a sharing-group name/identification code list anew (step 33). If a sharing-group name/identification code list has already been created (“YES” at step 32), then the processing of step 33 is skipped.

The center server 1 generates a unique identification code in such a manner that the code will not be one identical with identification codes that have been stored in the sharing-group name/identification code list (step 34). The generated identification code is stored in the sharing-group name/identification code list together with the corresponding sharing-group name (step 35). The generated identification code is stored in an identification code file and the file is transmitted from the center server 1 to the group creating computer (step 36).

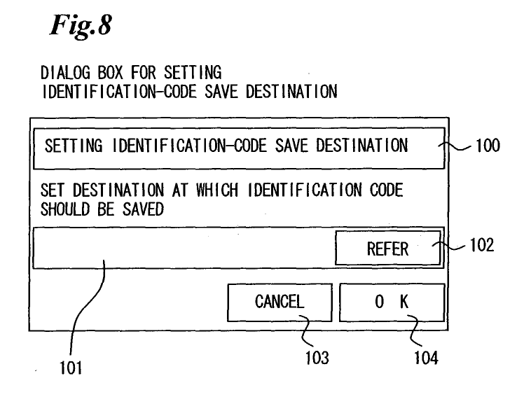

Upon receiving the identification code file transmitted from the center server 1 (step 25), the group creating computer displays a dialog box 100 (FIG. 8), which is for setting an identification-code storage destination, on the display screen of the display unit possessed by the group creating computer (step 26).

The dialog box 100 for setting an identification-code storage destination includes an area 101 that displays the storage destination of an identification code file, a reference area 102, a cancel area 103 and an OK area 104. A file dialog box (not shown) appears in response to clicking of the reference area 102 by the user of the group creating computer. A destination for installation of the identification code file is selected from the file dialog box that has appeared, whereupon the selected installation destination is displayed in the area 101. If the displayed installation destination is acceptable, the user of the group creating computer clicks the OK area 104. The identification code file is installed at the selected save destination (step 27).

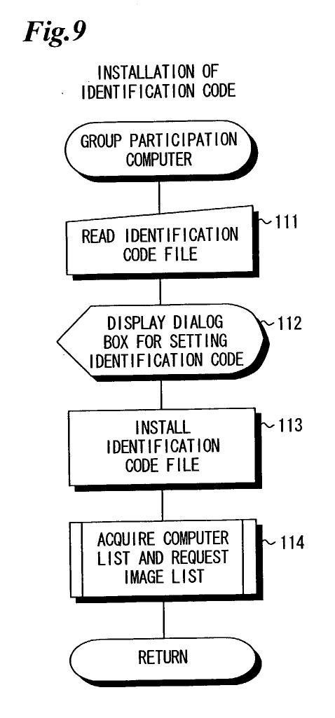

FIG. 9 is a flowchart illustrating processing for installing an identification code file.

An identification code file transmitted from the center server 1 is installed in the group creating computer, as described above. In order to install an identification code file in a computer (which shall be referred to as a “group participation computer”) other than the group creating computer, operation is as follows:

First, the identification code file is transmitted from the group creating computer to the group participation computer as by E-mail. The identification code file that has been transmitted is read by the group participation computer (step 111).

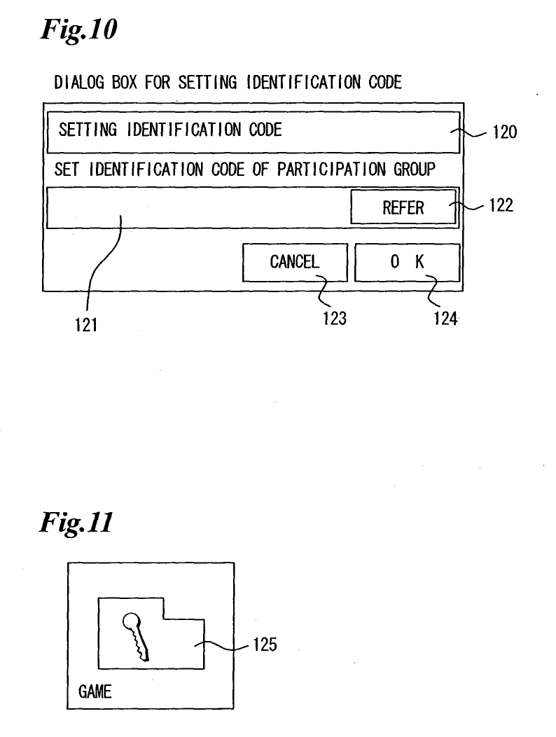

A content sharing program is launched at the group participation computer and the window 40 shown in FIG. 4 is displayed. If the “PARTICIPATE” menu item that is displayed by clicking on the “GROUP” participation menu 52 is clicked, or if the group participation icon 67 is clicked, a dialog box 120 (FIG. 10) for setting an identification code appears on the display screen of the display unit of the group participation computer (step 112).

The dialog box 120 includes an area 121 for displaying a group name that has been set, a reference area 122, a cancel area 123 and an OK area 124. A file dialog box appears in response to clicking of the reference area 122 by the user of the group creating computer. A destination for installation of an identification code file is displayed in the file dialog box that has appeared. If the displayed installation destination is acceptable, the user of the group creating computer clicks the OK area 124, whereupon the identification code file is installed (step 113). When the identification code file is installed, processing for acquiring a computer list and processing for requesting an image list is executed (step 114) in a manner described later. Participation in the group is acknowledged. As shown in FIG. 11, a folder 125 with a key symbol regarding the group in which participation has been allowed is displayed in the area 70 of the window 40 displayed by the group creating computer.

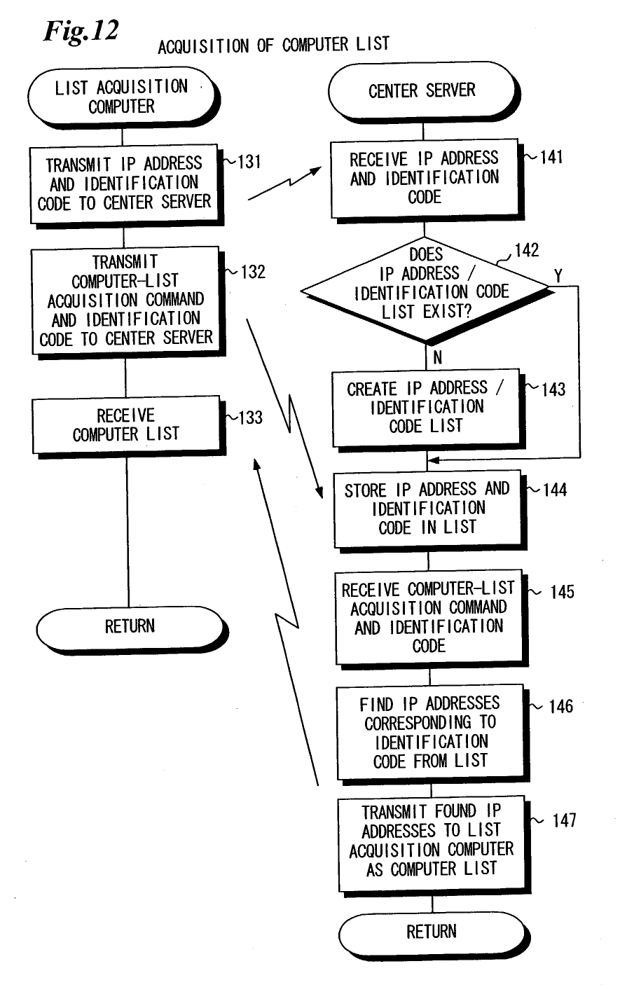

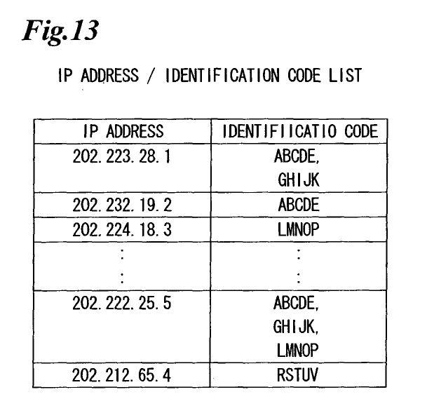

FIG. 12 is a flowchart illustrating processing for acquiring a computer list.

If an update button 68 is clicked on in a case where the content sharing program has been started up by the computer 2 and the window 40 is being displayed, processing for acquiring a computer list is executed. (A computer that executes processing for acquiring a computer list shall be referred to as a “list acquisition computer”.) Further, the processing for acquiring a computer list is executed immediately after the content sharing program is launched or when the group participation processing is executed as described above.

In either case, when computer-list acquisition processing starts, an IP address and identification code (this identification code is one that has been stored in the identification code file installed at step 27 in FIG. 3 or at step 113 in FIG. 9) are transmitted from the list acquisition computer to the center server (step 131).

Upon receiving the IP address and identification code transmitted from the list acquisition computer (step 141), the center server 1 checks to determine whether an IP address/identification code list has already been created in the center server 1 (step 142). If an IP address/identification code list does not exist in the center server 1 (“NO” at step 142), then the center server 1 creates an IP address/identification code list anew (step 143). If an IP address/identification code list has already been created in the center server 1 (“YES” at step 142), then the processing of step 143 is skipped. The IP address and identification code transmitted from the list acquisition computer are stored in the IP address/identification code list (step 144).

A computer-list acquisition command and the identification code are transmitted from the list acquisition computer to the center server 1 (step 132).

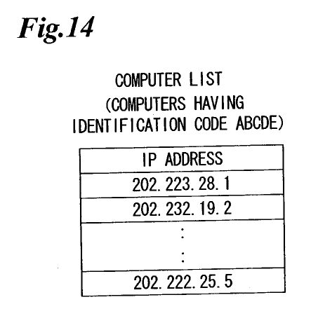

Upon receiving the computer-list acquisition command and the identification code transmitted from the list acquisition computer (step 145), the center server 1 finds IP addresses corresponding to the received identification code from the IP address/identification code list that has been stored in the center server 1 (step 146). The found IP addresses are transmitted to the list acquisition computer as a computer list (step 147), as shown in FIG. 14. (The computer list shown in FIG. 14 illustrates a case where an identification code “ABCDE” has been transmitted from the list acquisition computer. IP addresses corresponding to the identification code “ABCDE” are found from the IP address/identification code list and are transmitted to the list acquisition computer as the computer list.) The computer list indicates the sharing group having the sharing-group name specified by the identification code.

Upon receiving the computer list transmitted from the center server 1 (step 133), the list acquisition computer transmits an image-list request command, etc., to the computers 2 having the IP addresses in this computer list.

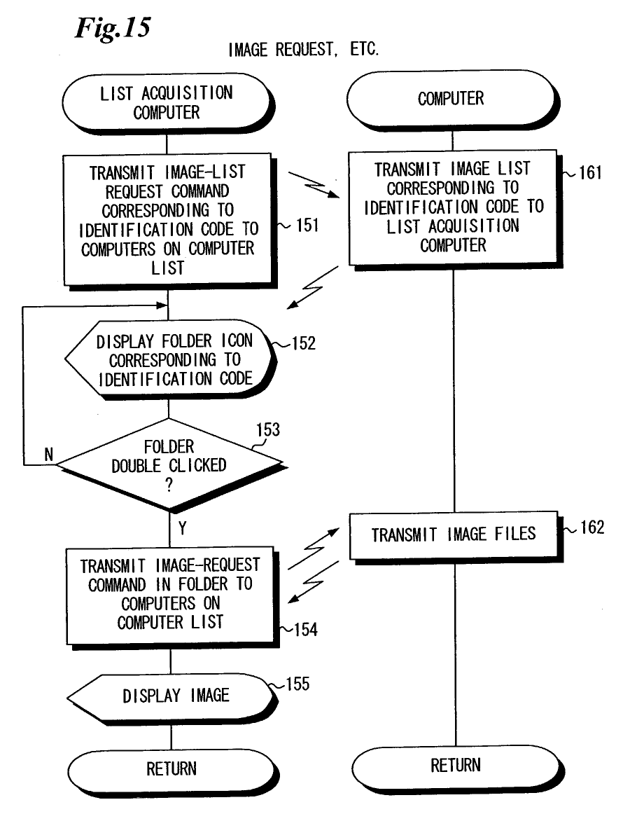

FIG. 15 is a flowchart illustrating processing in a case where the list acquisition computer requests another computer 2 for images.

Upon receiving the computer list from the center server 1, the list acquisition computer transmits the identification code, which was used when the computer list was acquired, and an image-list request command to all (or some) computers 2 having IP addresses stored in the computer list received (step 151).

An image list corresponding to the identification code is transmitted to the list acquisition computer by the computer 2 that has received the image-list request command transmitted from the list acquisition computer (step 161).

Upon receiving the image list transmitted from the computer 2, the list acquisition computer displays anew the folder icon corresponding to the identification code within the area 70 of the window 40 (step 152). Further, if the folder icon is double-clicked on by the user of the list acquisition computer (“YES” at step 153), the image-request command within the folder is transmitted to all computers 2 having the IP addresses contained in the computer list (step 154).

The computer 2 that has received the image-request command transmits the corresponding image files to the list acquisition computer (step 162).

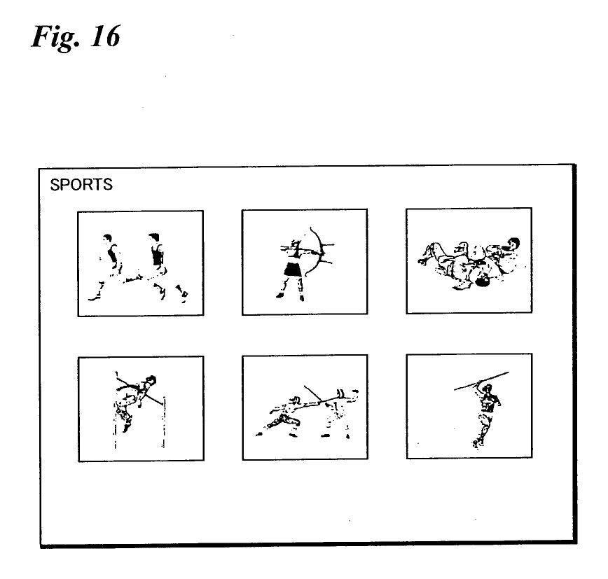

Upon receiving the image files transmitted from the computer 2, the list acquisition computer displays the images corresponding to the identification code on the display screen of the display unit of the list acquisition computer (step 155), as shown in FIG. 16.

The identification code file is applied initially only to a group creating computer that has created a group. Thereafter, the identification code file can be installed only in the group participation computer to which the identification code file has been applied by the user of the group creating computer. Only a computer in which a specific identification code file has been installed constitutes a sharing group and is capable of sharing content such as an image files.

As many apparently widely different embodiments of the present invention can be made without departing from the spirit and scope thereof, it is to be understood that the invention is not limited to the specific embodiments thereof except as defined in the appended claims.

What is claimed is:

1. A center server capable of communicating with one computer apparatus and another computer apparatus, comprising:
an identification code generating device for receiving a sharing-group creation command and data, which represents the address of said one computer apparatus, transmitted from said one computer apparatus, and generating a unique identification address in accordance with the received sharing-group creation command;
an identification code transmitting device for transmitting the identification code, which has been generated by said identification code generating device, to said one computer apparatus;
a list generating device for generating an address/identification code list in which the identification code generated by said identification code generating device and the address of said one computer apparatus are made to correspond to each other; and
a storage control device for storing the identification code and the address of said other computer apparatus, which have been transmitted from said other computer apparatus, in the address/identification code list.

2. A center server comprising:
a memory for storing an address/identification code list in which unique identification codes generated in the center server and addresses of computer apparatus correspond to each other;
a retrieval device for retrieving an address, which corresponds to an identification code transmitted from a computer apparatus, from the address/identification code list; and
an address data transmitting device for transmitting data, which represents the address retrieved by said retrieval device, to the computer apparatus that transmitted the identification code.

3. A computer apparatus comprising:
a first transmitting device for transmitting an identification code to a center server storing an address/identification code list in which identification codes and addresses of computer apparatus correspond to each other;
a receiving device for receiving address data transmitted from the center server in response to transmission of the identification code from said first transmitting device to the center server; and
a second transmitting device for transmitting a retrieval request for content, which corresponds to the identification code transmitted to the center server, to a computer apparatus having the address represented by the address data received by said receiving device.
